(19) United States
(12) Patent Application Publication
(10) Pub. No.: US 2014/0236867 A1
(43) Pub. Date: Aug. 21, 2014

(54) FRANKING IMPRINT DATA FOR A MAIL ITEM

(71) Applicants: Clemens Heinrich, Oranienburg (DE); Dirk Rosenau, Berlin (DE); Kai Nicolai, Berlin (DE)

(72) Inventors: Clemens Heinrich, Oranienburg (DE); Dirk Rosenau, Berlin (DE); Kai Nicolai, Berlin (DE)

(21) Appl. No.: 14/183,873

(22) Filed: Feb. 19, 2014

Related U.S. Application Data
(60) Provisional application No. 61/766,474, filed on Feb. 19, 2013.

(51) Int. Cl. G06Q 50/32; G06Q 10/08

(52) U.S. Cl. CPC G06Q 50/32; G06Q 10/083
USPC 705/408

(57) ABSTRACT

In a method for generating franking imprint data for a mail item to be shipped, a set of shipping options for the mail item, from among available shipping options stored in a first memory, is selected at a data processing device, and product vector data are generated from the selected set. A franking imprint authorization request, including the product vector data, is transmitted from the data processing device to a secure device, at which it is verified whether the transmitted product vector data are compatible with the available shipping options, also stored at the secure device. If so, franking imprint authorization data are returned from the secure device to the data processing device and the franking imprint data are generated in response thereto. If compatibility is not verified, request rejection data are returned from the secure device to the data processing device.

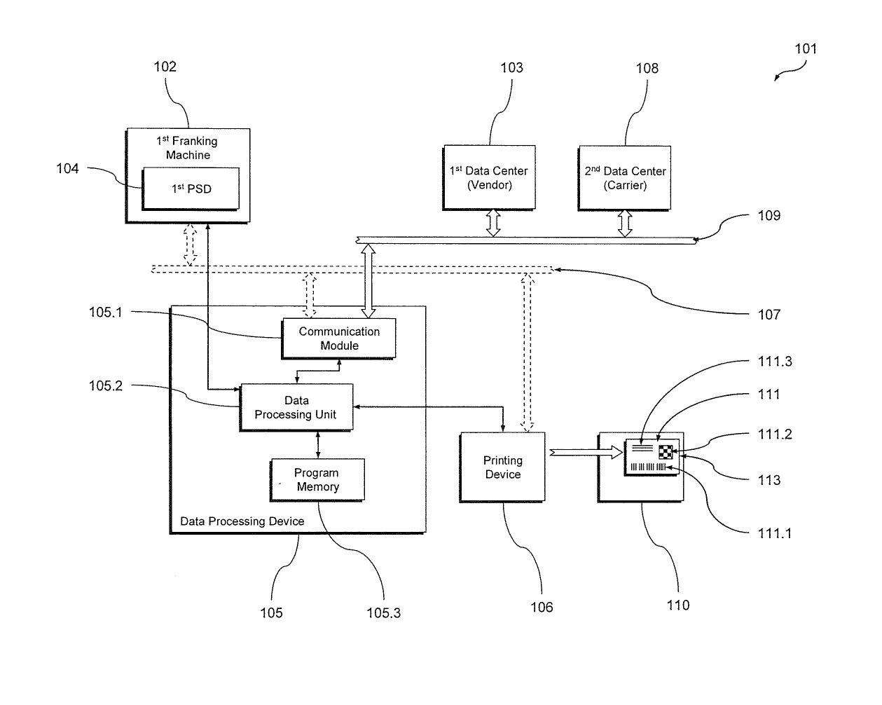

### RELATED APPLICATION

The present application claims the benefit of the filing date of Provisional Application 61/766,474, filed Feb. 19, 2013, the contents of which are incorporated herein by reference.

### BACKGROUND OF THE INVENTION

1. Field of the Invention

The present invention relates to a method for generating franking imprint data for a mail item to be shipped. It furthermore relates to a corresponding data processing system for generating franking imprint data for a mail item to be shipped, corresponding components of said arrangement as well as to a computer readable medium comprising program code for executing at least part of the method according to the invention in such an arrangement.

2. Description of the Prior Art

In the presently used postal transport systems, such as they are known, for example, from US 2010/0235303 A1 (Lynch; the entire disclosure of which is incorporated herein by reference), the mail items (such as letters, packages, parcels etc.) are typically provided with a value marking or a corresponding franking imprint (in the following generally also referred to herein as an indicium) that, among other things, serves as evidence for the payment of the necessary transport fees of the selected postal carrier. For this purpose, the value marking or the franking imprint normally contains a series of graphical verification features, for example alphanumeric characters, barcodes etc. that contain indicium information in coded or uncoded form. This information enables it to be determined whether the transport fees have been paid.

After the mail item has been transferred to the postal carrier, the carrier uses the indicium to verify whether the fees necessary for the transport have been paid. If the verification is successful, the postal carrier takes over the transport of the mail piece to the desired location; otherwise, it rejects the item (if applicable).

In many cases so called franking machines integrating a postal security device, a data processing unit and, in some cases, also a printing unit, are used to generate the indicium on a substrate such as the mail item itself or a label to be connected to the mail item. In some cases however, separate data processing devices, such as personal computers (PCs) or the like, are used are used to perform parts of the indicium generation for several reasons.

One of these reasons is the limited data processing capacity of special purpose data processing units such as the postal security devices of franking machines. Specific software run on a conventional PC connected to such a postal security device (e.g. of a franking machine) helps tracking and optimizing a customer's mail and postage costs and leverages the customer to take advantage of discounts offered with commercial postage products.

For example, Francotyp Postalia GmbH of Birkenwerder, Del., has released a software called Mailone™ supporting a customer in claiming discounted Commercial Base Pricing (CBP) by printing a delivery confirmation barcode and sending the CBP data to a postal carrier such United States Postal Service (USPS). The Mailone™ software runs on a customer's PC that is connected to a postal security device of a separate franking machine and to a label printer for printing the indicium. The customer's PC receives indicium data from the postal security device and causes the label printer to print a representation of the indicium onto a label which is then connected to the mail item to be shipped.

It will be appreciated that, in such a hybrid system configuration with a data processing device (such as a PC) receiving indicium data from a separate postal security device, in cases where there is no secure connection between the data processing device and the postal security device, fraudulent indicium data might be transferred to and printed via the data processing device by an external device simulating to be a valid postal security device. Such a fraudulent simulation might be performed subsequent to an attack unveiling the communication protocol between the data processing device and a valid separate postal security device. By this means, mail items with fraudulent indicia might be entered into the mail stream of a carrier forcing the latter to implement a sufficiently high survey ratio of the indicia of its mail stream to prevent undetected fraud.

A further reason for using separate data processing devices in generating printed indicia is the greater flexibility of the user interface provided by such separate data processing devices (e.g. PCs) compared to the user interface typically provided by such franking machines. Hence, with such external or separate data processing devices, typically, more user convenient menus may be displayed and data entry is also rendered more user friendly.

However, as outlined above, the use of such devices external to the franking machine brings along commercial as well as security problems, for example, when using unauthorized or outdated software and/or shipping options information (typically contained in so-called rate tables) which doesn't correspond to the actual requirements or product portfolio of the postal carrier.

Hence, there is a need to make sure that the data processing device in such a hybrid system always uses the appropriate data for selecting the shipping options forming a basis of the franking imprint generation, in particular, the calculation of the rate to be paid for shipping.

### SUMMARY OF THE INVENTION

An object of the present invention is to provide a method and a system for generating franking imprint data for a mail item to be shipped that, at least to a certain extent overcome the above disadvantages, and which in particular keep a sufficiently high level of security.

The present invention is based on the consideration that a simple and convenient way of generating franking imprint data for a mail item to be shipped while keeping a sufficiently high level of security is possible if the set of shipping options for the specific mail item to be shipped selected using the corresponding software running on the data processing device is checked against compatibility with a total set of available shipping options held in a secure data processing device (also generally referred to herein as a secure device). The secure device, typically, is a trusted device that has a specific secure logical binding with corresponding facilities of the postal carrier. Hence, the secure device forms a trust basis for the present franking imprint generating system accepted by the postal carrier. The secure device, typically, in a correspondingly secure communication, receives the appropriate, most recent data set representing the total set of available shipping options for the specific postal carrier. Hence, by checking the franking imprint authorization request of the data processing device against this trusted total shipping options set, it may be assured that the data processing device is only authorized for printing a franking imprint, if the authorization request matches the trusted total shipping options set. If the authorization request fails to pass this check, the authorization request is rejected and printing is denied.

It should be noted that, in certain cases communication between a user of the external data processing device or the secure device and a remote data center doesn't have to happen in exclusively electronic way. For example, a communication channel at least partially established by regular mail or telephone between the user and the remote data center may also be used. Furthermore, any other communication means from a communication device other than the data processing device may be used, such as e-mail, for example. However, any of the communication channels used may also be a purely electronic channel formed by a communications link between the respective data processing system components.

Hence, according to a first aspect of the present invention, there is provided a method for generating franking imprint data for a mail item to be shipped, comprising, in a selection step, at a data processing device, selecting a set of shipping options for the mail item from a first total set of available shipping options stored in a first memory, in a product vector generating step, at the data processing device, generating product vector data from the set of shipping options, in a request step, transmitting a franking imprint authorization request including the product vector data via a communication link from the data processing device to a secure device connected to the data processing device, in a verification step, at the secure device, verifying if the product vector data of the franking imprint authorization request are compatible with a second total set of available shipping options stored in a second memory of the secure device, if the verification step reveals that the product vector data are compatible with the second total set of available shipping options, returning franking imprint authorization data from the secure device to the data processing device and, at the data processing device, in a franking imprint data generation step, generating the franking imprint data in response to receipt of the franking imprint authorization data, if the verification step reveals that the product vector data are not compatible with the second total set of available shipping options, returning request rejection data from the secure device to the data processing device.

The secure device may be any logically and/or physically secured data processing unit that is trusted by the respective postal carrier. For example, it may be a so-called postal security device or security module typically used in a franking machine. Furthermore, the data processing device may be any desired unsuitable data processing device running a corresponding item of software allowing selection of the shipping options from the first total set of available shipping options. Preferably, the data processing device is a personal computer running such an item of shipping software providing a selecting functionality used in the selection step.

The second total set of available shipping options may be introduced into the secure device in any suitable way. For example, memory devices (such as smart cards, etc.) may be physically connected to the secure device for entering the data set containing the second total set of available shipping options. Preferably, in a shipping option loading step preceding the selection step, the second total set of available shipping options is loaded into the secure device via a logically secured communication link from a remote data center.

The respective total set of available shipping options may be present in the data processing device and the secure device, respectively, in any suitable representational form. Typically, at least one of the total set of available shipping options is stored in the first memory in the form of a first rate table data set and the second total set of available shipping options is stored in the second memory in the form of a rate table data set.

It will be appreciated that the first total set of available shipping options may be introduced into the first memory in any suitable way. In particular, this may be done in a similar way as described above for the second set of available shipping options. For example, the first and second total set of available shipping options may be introduced into the respective first and second memory as separate data sets received from a respective provider, for example, the postal carrier or a vendor of the secure device. Preferably, however, the first total set of available shipping options, in a shipping option set generation step preceding the selection step, is derived, at one of the data processing device and the secure device, from the second set of available shipping options. Hence, in a very simple way, security that the later authorization request will be compatible with the second total set of available shipping options is increased.

In certain variants of the invention allowing particularly simple and fast data processing at the data processing device, the first memory is located at the data processing device. However, with other embodiments of the invention, the first memory may also be located at the secure device, the data processing device, during the selection step, then accessing the first memory via a communications link between the data processing device, and the secure device. The latter variant has the advantage that the first total set of shipping options available is also held in a secure and trusted environment (where it is protected from tampering).

As outlined above, preferably, at least the communication link between the data processing device and the secure device is a logically secured communication link. Such logical security, in a well-known manner, may be achieved by one or more of a plurality of cryptographic means, including data encryption, digital signatures, digital certificates, etc. The same preferably applies to any further communication link used in the context of the present invention.

It will be appreciated that the respective total set of available shipping options may include any options provided by the postal carrier for specifying the service performed in the context of the shipment of the mail item, parcel etc. Preferably, the total set of available shipping options includes at least one of shipping type options, shipping rate options, additional shipping services options, shipping discount options, shipping timing options etc.

It will be appreciated that the shipping authorization data returned from the secure device to the data processing device may be simple authorization information allowing the release of the printing process, i.e. generation of the franking imprint. Preferably, the shipping authorization data comprises imprint data to be included in a franking imprint to be generated for the mail item. By this means, trusted data (since generated by the trusted secure device) for later verification by the postal carrier or other parties may be included into the franking imprint.

Hence, preferably, the imprint data comprise at least one of imprint authentication data, imprint identification data and payment confirmation data. Furthermore, preferably, the imprint data are cryptographically secured by the secure device.

It will be appreciated that, preferably, in a printing step, the franking imprint data are used for printing, under the control of the data processing device, a franking imprint via a printing device connected to the data processing device. The printing device may be a general purpose printer. It will be appreciated, however, that, with certain embodiments of the invention, the printing device may also be a printing device of a franking machine connected to the data processing device.

The present invention further relates to a data processing system adapted to execute a method for generating franking imprint data for a mail item to be shipped, comprising, a data processing device and a secure device connected via a communication link. The data processing device is configured to select, in a selection step, a set of shipping options for the mail item from a first total set of available shipping options stored in a first memory. The data processing device is further configured to generate, in a product vector generating step, product vector data from the set of shipping options. The data processing device is further configured to transmit, in a request step, a franking imprint authorization request including the product vector data via the communication link to the secure device. The secure device is configured to verify, in a verification step, at the secure device, if the product vector data of the franking imprint authorization request are compatible with a second total set of available shipping options stored in a second memory of the secure device. The secure device is configured to return, if the verification step reveals that the product vector data are compatible with the second total set of available shipping options, franking imprint authorization data to the data processing device. The secure device is further configured to return, if the verification step reveals that the product vector data are not compatible with the second total set of available shipping options, request rejection data to the data processing device. The data processing device is further configured to generate, in a franking imprint data generation step, the franking imprint data in response to receipt of the franking imprint authorization data from the secure device.

The embodiments and advantages as outlined above in the context of the method according to the invention may be obtained here to the same extent. Hence, in this respect reference is made to the explanations given above.

The present invention further relates to a data processing device being configured as the data processing device of such a system according to the invention. The present invention further relates to a secure device being configured as the secure device of an arrangement according to the invention.

The embodiments and advantages as outlined above in the context of the method according to the invention may be obtained to the same extent with such a processing device and such a secure device, respectively. Hence, in this respect reference is made to the explanations given above.

Finally, the present invention relates to a computer readable medium encoded with programming instructions to control execution of at least a part of the method according to the invention. It will be appreciated that with this program code contained in such a computer readable media and run on a suitable data processing device, the variants and advantages of the method is outlined above may be achieved to the same extent such that reference is made to the explanations given above in the context of the method according to the invention.

### BRIEF DESCRIPTION OF THE DRAWINGS

The single FIGURE is a block diagram of a preferred embodiment of a system for generating franking imprint data according to the invention using which a preferred embodiment of the method for generating franking imprint data according to the invention may be executed.

### DESCRIPTION OF THE PREFERRED EMBODIMENTS

In the following, a preferred embodiment of a system 101 according to the invention adapted to execute a preferred embodiment of the method for generating franking imprint data using a secure device of a franking machine 102 will be described in greater detail with reference to the FIGURE.

As can be seen from the FIGURE the arrangement 101 has remote data center 103 (operated by a vendor of the franking machine 102), the franking machine 102 with a secure device in the form of a postal security device (PSD) 104, a data processing device 105 and a printing device 106. The franking machine 102 and the printing device 106, in the present embodiment, are both connected directly to the data processing device 105 via a point-to-point connection, such as a USB connection or the like.

It will be appreciated however that, with other embodiments of the invention, either one of the franking machine 102 and the printing device 106 may be connected to the data processing device via a data network, such as e.g. a local area network (LAN), as it is indicated in the FIGURE by the dashed contour 107.

In the present embodiment, the system 101 has a further remote data center, namely a carrier data center 108 (operated by a postal carrier intended to ship mail items 109). Both data centers 103, 108 are located remote from the data processing device 105 and may be connected to the data processing device 105 via a communication module 105.1 of the data processing device 105 and a further data network 109 (such as, for example, a wide area network as e.g. the Internet, or a telecommunication network).

The franking machine 102 may be a conventional franking machine used to generate franking imprints either directly on a mail item (such as a letter or the like) or on a label which is to be associated to a mail item (e.g. to be connected to a parcel or the like).

The postal security device 104 may be a physically and/or logically secured data processing unit providing, in a conventional manner, among others, data security functionality to secure certain data, in particular, accounting relevant data, from unauthorized and/or undetected access. To this end, one or more cryptographic functions (including the appliance of one or more cryptographic algorithms as well as one or more cryptographic keys) may be implemented within the postal security device 104. It will be appreciated that any further postal security device mentioned in the following may be configured in such a manner.

The data processing device 105, in the present example, is formed by a personal computer (PC) and comprises a data processing unit in the form of a central processing unit (CPU) 105.2 connected to a program memory 105.3 holding a program code. The data processing unit 105.2 is running this program code to provide and execute the functionality of the data processing device 105 as it will be explained in the following.

The program code provided in the program memory 105.3, among others, comprises a mailing software (such as, for example, a software called Mailone™ issued by Francotyp Postalia GmbH of Birkenwerder, Del.) or program code MS supporting a user of the franking machine 102 in providing statistical data regarding the mail items 110 processed to the carrier intended to ship the mail items 110 in order to obtain rebates or discounts, respectively, from the carrier. For example, this software may support the user in claiming so-called discounted Commercial Base Pricing (CBP) by printing a delivery confirmation (one-dimensional) barcode 111.1 as a part of a printed indicium 111 (representing CBP data) and sending corresponding CBP data to the postal carrier (such as e.g. the United States Postal Service).

The program code provided in the program memory 105.3, among others, may be adapted to protect data stored in the memory 105.3 or, if need be, in another memory connected to the central processing unit (CPU), e.g. a memory holding a database comprising such data to be protected. The protected data may encompass, among others, the CBP reporting data, event logging data and other data. In the present example, the data to be protected are held in a database to which the central processing unit (CPU) has access.

To protect this data, the database itself is encrypted using a suitable encryption mechanism. The database may, for example, be a Microsoft® Access® 2007 database and the encryption mechanism used may be the encryption mechanism built in to the Microsoft® Access® database. The cryptographic key DBEK used for the encryption of the database is preferably hidden in the source code of the mailing software. To this end, a suitable software tool (typically a so called obfuscator) may be used to obfuscate the source code of the mailing software and makes it very difficult to locate the cryptographic key DBEK.

As will be explained in the following, the mailing software may be used to generate franking imprint data for the mail item 110 to be shipped by the carrier. Generating the franking imprint data is done using a first set TSSO1 of available shipping options stored in a first memory 105.3 of the data processing device 105 and a second total set TSSO2 of available shipping options stored in a second memory of the postal security device 104.

First, in a shipping option loading step, the second total set TSSO2 of available shipping options is loaded in the form of an (eventually suitably authenticated) rate table data set into the postal security device 104 via a logically secured communication link from one of the remote data centers 103 and 108.

In a subsequent shipping option set generation step, the first total set TSSO1 of available shipping options is derived at either the data processing device 105 or the postal security device 104, from the second set TSSO2 of available shipping options and stored in the first memory 105.3 of the data processing device 105.

Once this is done, the arrangement 101 is available for operation and generating indicia or franking imprints 111. If generation of such a franking imprint 111 for a specific mail item 110 to be shipped by the postal carrier is desired, the user of the data processing device 105, in a selection step, via a corresponding user interface of the data processing device and using the mailing software, selects a set of shipping options SSOMI for the mail item from the first total set TSSO1 of available shipping options stored in the first memory 105.3.

The mailing software of the data processing device 105, in a product vector generating step, generates product vector data PVD from the set SSOMI of shipping options selected for the specific mail item 110 to be shipped.

In a request step, the data processing device 105 transmits a franking imprint authorization request FIAR including the product vector data PVD via its (preferably logically secured) communication link to the postal security device 104.

The postal security device, in a subsequent verification step, verifies if the product vector data PVD of the franking imprint authorization request FIAR received from the data processing device 105 is compatible with the second total set TSSO2 of available shipping options stored in the second memory of the postal security device 104. Such compatibility may be defined in any suitable way. Typically, the check is made if the selected set of shipping options SSOMI (represented by the product vector data PVD) is a set of shipping options that may be generated according to the rules and options stored in the rate table representing the second total set SSO2 of available shipping options.

In case, if the verification step reveals that the product vector data PVD are compatible with the second total set SSO2 of available shipping options, the postal security device 104 returns franking imprint authorization data FIAD to the data processing device 105 via their communication link.

If this is the case, in a franking imprint data generation step, the franking imprint data FID are generated at the data processing device 105 in response to receipt of the franking imprint authorization data FIAD.

In a printing step, the data processing device 105 uses the franking imprint data FID for generating indicium data IND (representing the total franking imprint 111) for printing the franking imprint 111 using the printing device 106. In the present example, the printing device 106 is a general purpose printer. It will be appreciated, however, that, with certain embodiments of the invention, the data processing device 105 may also use the printing device of the franking machine 102 to generate the franking imprint 111.

In case that the verification step reveals that the product vector data PVD are not compatible with the second total set SSO2 of available shipping options, however, the postal security device 104 returns request rejection data RRD to the data processing device 105, such that the latter is inhibited from generating a valid franking imprint.

As outlined above, preferably, at least the communication link between the data processing device 105 and the postal security device 104 is a logically secured communication link. Such logical security, in a well-known manner, may be achieved by one or more of a plurality of cryptographic means, including data encryption, digital signatures, digital certificates, etc. The same preferably applies to any further communication link used in the context of the present invention. Such cryptographic securing typically includes at least one secret commonly known by the data processing device 105 and the postal security device 104.

It will be appreciated that the respective total set TTSO1, TTSO2 of available shipping options may include any options provided by the postal carrier for specifying the service performed in the context of the shipment of the mail item 110. Preferably, the total set of available shipping options includes at least one of shipping type options, shipping rate options, additional shipping services options, shipping discount options, shipping timing options etc.

In the present example, the franking authorization data FAD returned from the postal security device 104 to the data processing device 105 comprise imprint data FID to be included in the franking imprint 111 to be generated for the mail item 110. By this means, trusted data (since generated by the trusted postal security device 104) for later verification by the postal carrier or other parties are included into the franking imprint 111.

In the present case, the imprint data FID comprise imprint authentication data FIAUTHD (such as a digital signature over certain parts of the imprint data), imprint identification data FIID (such as e.g. a specific product code associated to the selected product vector data PVD) and payment confirmation data PCD (in particular, the amount of postage paid or deducted from the funds held in the postal security device 104, respectively). Furthermore, in the present example, the imprint data FID are cryptographically secured by the postal security device. To this end, for example, they may be encrypted, digitally signed or accompanied by a digital certificate.

It will be appreciated that the franking imprint 111 may comprise a representation of the indicium data IND in any suitable form allowing later retrieval and, eventually, further verification of the indicium data IND (e.g. during shipment of the mail item 110 by the carrier). Preferably, the data processing device 105 generates print data PD from these indicium data IND and sends the print data PD to the printing device 106, the print data PD comprising data for a machine readable representation of the indicium data IND. Any type of machine readable representation may be used. Preferably, the data for the machine readable representation comprise two-dimensional barcode data to generate a two-dimensional barcode 111.2. Furthermore, the indicium may also comprise clear human readable text as indicated by the contour 111.3

The present invention was described in the foregoing using an example wherein an indicium 111 is printed on a label 113 to be associated (e.g. physically connected) to the mail item 110. It will be appreciated however that, with other embodiments of the invention, the indicium may also be printed directly onto the mail item.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for generating franking imprint data for a mail item to be shipped, comprising,
in a selection step, at a data processing device, selecting a set of shipping options for said mail item from a first total set of available shipping options stored in a first memory;
in a product vector generating step, at said data processing device, generating product vector data from said set of shipping options;
in a request step, transmitting a franking imprint authorization request including said product vector data via a communication link from said data processing device to a secure device connected to said data processing device;
in a verification step, at said secure device, verifying if said product vector data of said franking imprint authorization request are compatible with a second total set of available shipping options stored in a second memory of said secure device;
if said verification step reveals that said product vector data are compatible with said second total set of available shipping options, returning franking imprint authorization data from said secure device to said data processing device and, at said data processing device, in a franking imprint data generation step, generating said franking imprint data in response to receipt of said franking imprint authorization data;
if said verification step reveals that said product vector data are not compatible with said second total set of available shipping options, returning request rejection data from said secure device to said data processing device.

2. The method according to claim 1, wherein at least one of said secure device is a security module of a franking machine and said data processing device is a personal computer running an item of shipping software providing a selecting functionality used in said selection step.

3. The method according to claim 1, wherein, in a shipping option loading step preceding said selection step, said second total set of available shipping options is loaded via a logically secured communication link from a remote data center into said secure device.

4. The method according to claim 1, wherein at least one of said total set of available shipping options is stored in the first memory in the form of a first rate table data set and said second total set of available shipping options is stored in the second memory in the form of a rate table data set.

5. The method according to claim 1, wherein, in a shipping option set generation step preceding said selection step, said first total set of available shipping options is derived, at one of said data processing device and said secure device, from said second set of available shipping options.

6. The method according to claim 1, wherein
said first memory is located at said secure device; and
via said data processing device, during said selection step, accessing said first memory via a communications link between said data processing device, and said secure device.

7. The method according to claim 1, wherein said first memory is located at said data processing device.

8. The method according to claim 1, wherein said communication link between said data processing device and said secure device is a logically secured communication link.

9. The method according to claim 1, wherein said total set of available shipping options includes at least one of shipping type options, shipping rate options, additional shipping services options, shipping discount options, shipping timing options.

10. The method according to claim 1, wherein said shipping authorization data comprises imprint data to be included in a franking imprint to be generated for said mail item.

11. The method according to claim 10, wherein said imprint data comprise at least one of imprint authentication data, imprint identification data and payment confirmation data.

12. The method according to claim 10, wherein said imprint data are cryptographically secured by said secure device.

13. The method according to claim 1, wherein, in a printing step, said franking imprint data are used for printing, under the control of said data processing device, a franking imprint via a printing device connected to said data processing device.

14. A data processing system adapted to execute a method for generating franking imprint data for a mail item to be shipped, comprising,
a data processing device and a secure device connected via a communication link;
said data processing device being configured to select, in a selection step, a set of shipping options for said mail item from a first total set of available shipping options stored in a first memory;
said data processing device being configured to generate, in a product vector generating step, product vector data from said set of shipping options;
said data processing device being configured to transmit, in a request step, a franking imprint authorization request including said product vector data via said communication link to said secure device;
said secure device being configured to verify, in a verification step, at said secure device, if said product vector data of said franking imprint authorization request are compatible with a second total set of available shipping options stored in a second memory of said secure device;
said secure device being configured to return, if said verification step reveals that said product vector data are compatible with said second total set of available shipping options, franking imprint authorization data to said data processing device;
said secure device being configured to return, if said verification step reveals that said product vector data are not compatible with said second total set of available shipping options, request rejection data to said data processing device;
said data processing device being configured to generate, in a franking imprint data generation step, said franking imprint data in response to receipt of said franking imprint authorization data from said secure device.

15. The system according to claim 14, wherein at least one of said secure device is a security module of a franking machine and said data processing device is a personal computer running an item of shipping software providing a selecting functionality used in said selection step.

16. The system according to claim 14 further comprising a remote data center, said secure device and said remote data center being configured to load, in a shipping option loading step preceding said selection step, said second total set of available shipping options via a logically secured communication link from said remote data center into said secure device.

17. The system according to claim 14, wherein at least one of said total set of available shipping options is stored in the first memory in the form of a first rate table data set and said second total set of available shipping options is stored in the second memory in the form of a rate table data set.

18. The system according to claim 14, wherein one of said data processing device and said secure device is configured to derive, in a shipping option set generation step preceding said selection step, said first total set of available shipping options from said second set of available shipping options.

19. The system according to claim 14, wherein
said first memory is located at said secure device; and
said data processing device being configured to access, during said selection step, said first memory via said communications link between said data processing device, and said secure device.

20. The system according to claim 14, wherein said first memory is located at said data processing device.

21. The system according to claim 14, wherein said communication link between said data processing device and said secure device is a logically secured communication link.

22. The system according to claim 14, wherein said total set of available shipping options includes at least one of shipping type options, shipping rate options, additional shipping services options, shipping discount options, shipping timing options.

23. The system according to claim 14, wherein said shipping authorization data comprises imprint data to be included in a franking imprint to be generated for said mail item.

24. The system according to claim 23, wherein said imprint data comprise at least one of imprint authentication data, imprint identification data and payment confirmation data.

25. The system according to claim 23, wherein said secure device is configured to cryptographically secure said imprint data.

26. The system according to claim 14, further comprising a printing device connected to said data processing device, said printing device being configured to print, in a printing step, a franking imprint using said franking imprint data under the control of said data processing device.

27. A non-transitory, computer-readable data storage medium encoded with programming instructions, said data storage medium being distributively loaded into a data processing device and a secure device, and said programming instructions causing said data processing device and said secure device to:
at said data processing device, select a set of shipping options for said mail item from a first total set of available shipping options stored in a first memory;
at said data processing device, generate product vector data from said set of shipping options;
transmit a franking imprint authorization request including said product vector data via a communication link from said data processing device to said secure device;
at said secure device, verify if said product vector data of said franking imprint authorization request are compatible with a second total set of available shipping options stored in a second memory of said secure device;
if said verification reveals that said product vector data are compatible with said second total set of available shipping options, return franking imprint authorization data from said secure device to said data processing device and, at said data processing device, generate said franking imprint data in response to receipt of said franking imprint authorization data;
if said verification reveals that said product vector data are not compatible with said second total set of available shipping options, return request rejection data from said secure device to said data processing device.
